(19) United States
(12) Patent Application Publication
(10) Pub. No.: US 2008/0084262 A1
(43) Pub. Date: Apr. 10, 2008

(54) SHIMMING OF MAGNET SYSTEMS

(76) Inventor: Paul Beasley, Oxfordshire (GB)

Correspondence Address: SCHIFF HARDIN, LLP;PATENT DEPARTMENT, 6600 SEARS TOWER, CHICAGO, IL, 60606-6473, US

(21) Appl. No.: 11/869,856

(22) Filed: Oct. 10, 2007

(30) Foreign Application Priority Data
Oct. 10, 2006 (GB) 0620033.1

(51) Int. Cl. H01F 6/04; H01F 5/00; H01F 7/06

(52) U.S. Cl. 335/216; 335/300

(57) ABSTRACT

A primary magnetic coil system is composed of multiple coil portions supported in predetermined relative positions, the multiple coil portions being electrically connected in series and carrying a common primary coil current during operation. The system has a corrective component that selectively causes a corrective electric current to be supplied to a subset of the coil portions.

### BACKGROUND OF THE INVENTION

1. Field of the Invention

The present invention relates to improving the homogeneity of magnetic fields generated in electromagnets, particularly magnetic fields generated by superconducting magnet arrangements utilized in magnetic resonance imaging (MRI) systems.

2. Description of the Prior Art

It is well known that, in order to achieve, over the field of view (FOV) of an MRI system, the high degree of field homogeneity required of the magnetic fields employed, corrective measures need to be taken, since the powerful fields as generated by the primary superconducting magnet coils can be inhomogeneous to an unacceptable extent.

A commonly used corrective measure, called “shimming” involves the measurement of the characteristics of the magnetic field to identify its degree of spatial homogeneity and the calculation of a specific field pre-distortion necessary to correct inhomogeneities to a prescribed extent. This field pre-distortion can be achieved in a number of ways, for example by means of a strategically placed array of suitably driven secondary magnetic coils, and/or by strategic physical displacement of some of the primary coils, so as to provide a corrected field with adequate homogeneity. Shimming can also be performed by the use of strategically placed pieces of ferromagnetic material.

### SUMMARY OF THE INVENTION

It is preferable, from the standpoints of cost and reliability, to limit the number of coils used, and thus it is preferred where possible to avoid the use of secondary coils. However, there is now a tendency to fabricate the primary coils by winding them into pre-defined journals of a common former, and to encapsulate them. This means that the relative position of the coils cannot be readily or economically mechanically adjusted at low temperatures to effect shimming. A problem thus arises in relation to the use of primary coil windings for mechanical shimming, and it is an object of this invention to address that problem with a view to solving, or at least ameliorating it.

The present invention accordingly provides a magnet system for generating a substantially homogeneous magnetic field within a region. The system includes a primary magnetic coil system for generating said substantially homogeneous magnetic field, which primary magnetic coil system comprises a number of primary coil portions supported in predetermined relative positions. The multiple primary coil portions are electrically connected in series and carry a common primary coil current during operation. The primary magnetic coil system further has corrective component that selectively causes a corrective electric current to be supplied to a subset of the primary coil portions. The corrective component superposes the corrective electric current on the primary coil current in the subset of primary coil portions, so the homogeneity of the magnetic field within the region is improved.

The subset of primary coil portions are preferably disposed electrically adjacent one another. The primary coil portions may be formed of superconducting material, which, in use, is cooled to a temperature at which superconductivity is possible. In such embodiments, the corrective component may be a superconducting switch connected across the subset of primary coil portions.

In certain embodiments, the multiple primary coil portions are supported in predetermined relative positions on a former. The primary coils may be wound into pre-defined channels of a common former, and encapsulated therein. Alternatively, the primary coils may be wound upon a common, pre-molded former and encapsulated thereon.

At least one of the subset of primary coil portions may be an end coil portion of the primary magnetic coil system.

In certain embodiments, the multiple primary coil portions are supported in predetermined relative positions on a former, and the at least one of the subset of primary coil portions is an end coil portion of the primary magnetic coil system supported upon the former proximate one end thereof.

### BRIEF DESCRIPTION OF THE DRAWINGS

FIG. 1 shows, in schematic form, a typical primary coil layout in a conventional superconductive magnet system.

FIGS. 2-7 show, in similar form to FIG. 1, the primary coil configurations utilized in superconductive magnet systems according to embodiments of the present invention.

### DESCRIPTION OF THE PREFERRED EMBODIMENTS

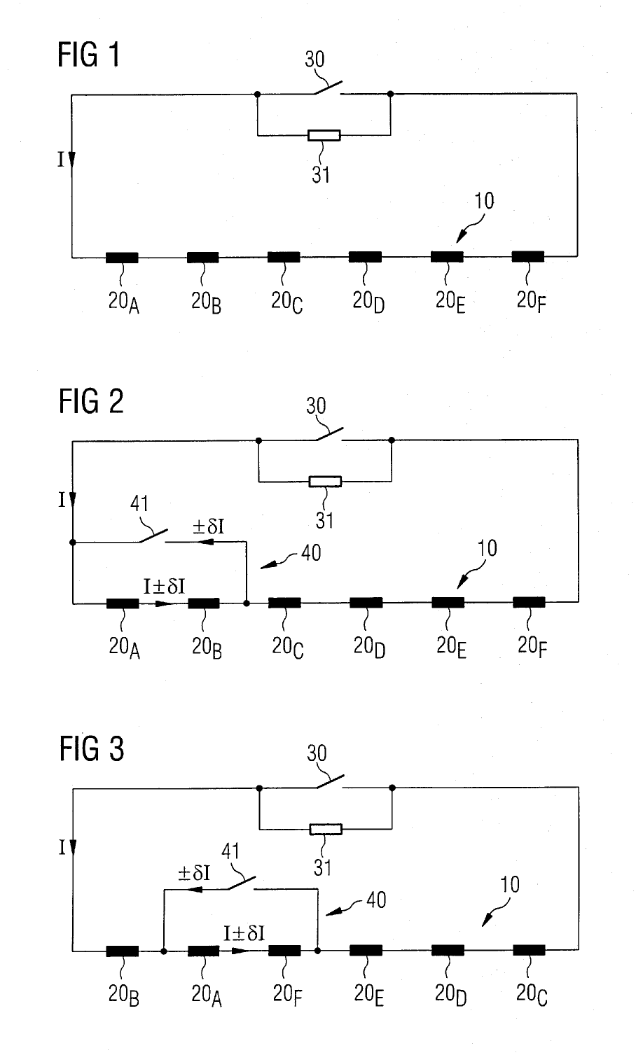

FIG. 1 illustrates a conventional arrangement wherein all coil portions 20_{A} to 20_{F} are electrically connected in series, and carry a common electrical current l.

A known primary coil system 10 of a powerful superconductive magnet intended for use in an MRI system typically has a coil system including a number of coil portions 20_{A}, to 20_{F} all connected in series, and across which is connected a superconducting switch 30 by means of which a large current (in the order of several hundred amperes) can be caused to flow through the primary coil system 10. A resistor 31 is conventionally connected across the superconducting switch, to protect the switch. The coil portions 20 may be wound upon a common, pre-molded former (not shown) and encapsulated thereon. As mentioned above, it is not readily or economically possible, with such a coil system, to pre-distort the powerful magnetic field generated by the primary coil system 10 by changing the physical position of one or more of the coil portions 20 relative to the remainder at low temperature.

The present invention will now be explained with reference to certain embodiments, involving a superconducting primary coil system comprising six coil portions. The term “coil portion” is used to signify an individual coil of a coil system. The coil portions will be labeled respectively 20_{A}, 20_{B}, 20_{C}, 20_{D}, 20_{E} 20_{F}, such that coil portions 20_{A} and 20_{F} are end coil portions, physically located at respective opposite ends of the coil system; coil portions 20_{B} and 20_{E} are physically located respectively next to end coil portions 20_{A} and 20_{F}; and coil portions 20_{B} and 20_{E} are physically located next to each other, and respectively next to coil portions 20_{B} and 20_{F}, and physically located towards the centre of the coil system.

Thus, in accordance with one embodiment of the invention, and as shown by way of example in FIG. 2, in which components common to FIG. 1 carry the same reference numbers, a corrective means, generally shown at 40, is provided for selectively applying a relatively small correction current □l to a subset of the primary coil portions. The correction current may be of a same or opposite polarity to the main current in the primary coil system 10, such that the total current flowing through each coil portion of the subset is l±δl. The magnitude and polarity of the correction current δl is selected such as to compensate, at least in part, for inhomogeneity in the magnetic field generated by the primary coil system 10 as a whole. Typically, as previously mentioned, assessment of the degree of correction, or shimming, required involves the measurement of the characteristics of the magnetic field generated by the primary coil system 10 in its operative configuration, thereby to reveal its degree of spatial homogeneity and to aid in the calculation of a specific field pre-distortion necessary to correct inhomogeneities to a prescribed extent.

In this example, the corrective means 40 includes a further superconductive switch 41 connected across a subset, in this case, two (namely 20_{A} and 20_{B}) of the coil portions 20 of the primary magnet system 10. It will be noted that, in this example, the coil portions 20_{A} and 20_{B} to which correction current is applied are disposed electrically adjacent one another. The inventor does not consider it necessary to connect a further resistor across superconducting switch 41 in view of the relatively low magnitude of the corrective current δl, and that resistor 31 effectively bypasses switch 41 as well as switch 30. Of course, in certain applications it may be found beneficial to place a resistor directly across switch 41, and such arrangements fall within the scope of the present invention.

It will be noted that, in this example, and indeed preferably bearing in mind the nature of the shimming function to be performed, at least one of the subset of coil portions 20_{A} and 20_{B} adapted to receive corrective current δl, is an end coil portion 20_{A} of the primary magnetic coil system 10, although other coil portions may be selected to receive correction current instead of, or in addition to, the end portions.

FIG. 3 illustrates another embodiment of the invention. In this embodiment, coil portions 20_{A} and 20_{F}, which receive the corrective current δl, are not located electrically adjacent to the superconductive switch 30. It is preferred that the coils 20_{A} and 20_{F} are electrically adjacent to one another, to facilitate a common corrective current □l to pass through them. However, their positioning within the overall series circuit is not important. Coil portions 20_{A} and 20_{F} are end coil portions, so are not physically adjacent one another.

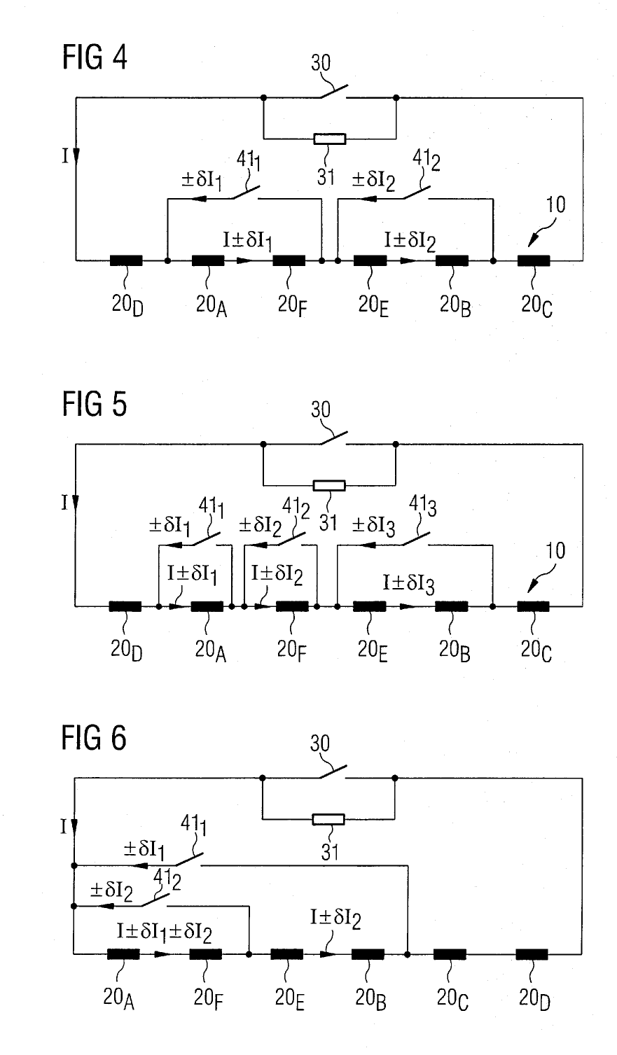

FIG. 4 illustrates another embodiment of the invention. According to this embodiment, two subsets of coil portions each receive a corrective current δl₁, δl₂ through a respective superconductive switch 41₁, 41₂. The corrective currents need not be equal. Preferably, the magnitude and direction of the corrective currents are calculated so as to achieve a maximum of compensation for inhomogeneity in the basic magnetic field of the primary coils system (known as shimming). In FIG. 4, a first subset of the coil portions includes coil portions 20_{A} and 20_{F}, being the end coil portions. This first subset receives a first corrective electrical current ±δI₁, such that each coil element in the first subset carries a total current of l±δl₁. A second subset of the coil portions includes coil portions 20_{B} and 20_{E}, being the coil portions next to the end coil portions. This second subset receives a second corrective electrical current ±δl₂, such that each coil element in the first subset carries a total current of l±δl₂. The remaining coil portions 20_{C} and 20_{D} receive the common electrical current l. Since primary magnet systems are typically very symmetrical, this may be a useful arrangement, allowing each pair of symmetrically arranged coil portions to receive a slightly different drive current. This arrangement should be effective in eliminating even-order harmonics from the overall magnetic field of the system.

In some arrangements, it may be advantageous to adjust the current though individual coils. By asymmetrically applying current to a symmetrically positioned pair of coils, odd-order harmonic distortion may be shimmed from an overall magnetic field. In addition, some coil systems may have an odd number of coils, and it may be found advantageous to apply a corrective current to the central coil, rather than to a pair of symmetrically arranged coils. Furthermore, some coil arrangements are not symmetrical, and in such arrangements it is particularly likely that application of corrective currents to individual coils would be appropriate. FIG. 5 illustrates an embodiment of the present invention in which two coil portions 20_{A} and 20_{F} each receive a dedicated corrective current, δl₁ and δl₂ respectively through respective superconductive switches 41₁ and 41₂. In this embodiment, each of coil portions 20_{A}, 20_{F} may be considered to be a subset of coil portions, comprising a single coil portion. In addition, a subset of coil portions including coil portions 20_{E} and 20_{B} receive a corrective current of δl₃ through a superconductive switch 41₃. As noted above, 20_{A} and 20_{F} are end coil portions, while 20_{B} and 20_{E} are coil portions placed next to the end portions. The corrective current δl₃ and the average value of δl₁ and δl₂ ((δl₁+δl₂)/2) are preferably selected to compensate for even-order inhomogeneity in the overall magnetic field, while the actual values of δl₁ and δl₂ are adjusted to compensate for odd-order inhomogeneities. Asymmetry in the positioning of the coils may be compensated for in this manner.

In any embodiment, some coil elements may be arranged in subsets of more than one, to receive common corrective electrical currents such as □l₃ shown in FIG. 5, while other coil components may be arranged in subsets of one, to receive an individual corrective current, such as δl₁ δl₂ in FIG. 5.

It is also possible, according to the present invention, that any particular coil portion may be included within more than one subset of coil portions. FIG. 6 shows an arrangement wherein end coil portions 20_{A} and 20_{F} receive a total current of (l±δl₁±δ□l₂), while coil portions 20_{B} and 20_{E} receive a total current of (l±δl₂). Computer modeling of the effect of each corrective current may be employed to determine the most effective circuit arrangement for applying corrective electrical currents according to the present invention.

The method of compensating for field homogeneities by adjusting the total current flowing through certain coil portions, according to the present invention, may be referred to as electrical shimming. The electrical shimming arrangements and methods provided by the present invention are primarily intended to enable relatively fine adjustments to currents flowing in coil portions which have been calculated to provide a homogeneous field, but which, on first operation, require some adjustment to provide the designed magnetic field quality.

An advantage of the present invention is that coil systems which have the coil portions fixed in position, such as when impregnated with resin onto the former may be shimmed without the use of large quantities or magnetic material such as iron. Conventionally, a large mass of iron or other suitable material was placed in the vicinity of the coil structure to provide field compensation (shimming). By using the electrical shimming method of the present invention, such large quantities of shimming material are not required. This may result in a smaller, lighter final magnet structure, and a reduction in labor time required to install a magnet.

In other types of magnet, it is possible to physically move individual coil portions with respect to one another. This is typically done at room temperature. For superconducting magnets, the magnet is then cooled to superconducting temperature, and the field homogeneity measured. Sometimes, the expected field homogeneity is not achieved. Further inhomogeneity may be introduced due to physical movement of the coils, caused by either or both of the drop in temperature, or magnetic forces acting on the coil portions when in operation. Conventionally, this further inhomogeneity is compensated for either by provision of shimming material as described above, or by bringing the magnet back to room temperature, and performing another position adjustment to the coil portions. The electrical shimming method of the present invention may be used to compensate for the further inhomogeneity, eliminating the need for costly and time consuming room-temperature adjustment and re-cooling, or provision of shim material.

The electrical shimming method and arrangement of the present invention may be found suitable for use in addition to any known method of shimming, for providing improved magnetic field homogeneity.

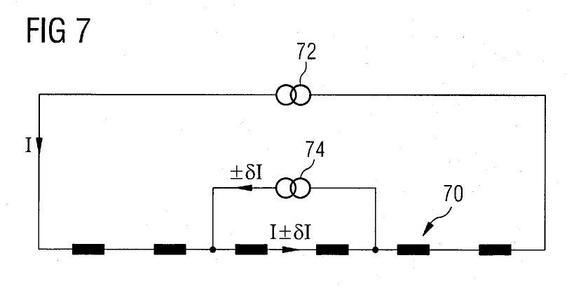

The present invention has been described with particular application to superconducting electromagnet structures. In superconducting electromagnet structures, the main coil current l and any corrective currents □l are applied as appropriate when the electromagnet is brought into operation (known as ramping-up), and the currents, once introduced into the respective circuits, continue to flow practically indefinitely without further energy input. In such superconducting electromagnets, the required currents are applied, and then the current leads may be disconnected, or at least are not further used. The present invention may also be applied to resistive electromagnets. For resistive electromagnets, it is not necessary to cool the electromagnet to cryogenic temperatures, as is necessary with superconducting electromagnets, although some cooling may be required to remove heat generated by passage of electric current through the resistance of the coils of the electromagnet. However, it is necessary to maintain the supply of power to resistive coils in order to keep current flowing in resistive coils. FIG. 7 shows an embodiment of the present invention wherein a main current source 72 provides a main current l to a resistive electromagnet 70, while a corrective current source 74 provides a corrective current □l to a subset of the coils of the resistive electromagnet.

It will be appreciated that the correction current injected into the selected coil portion or portions 20 may be of positive or negative polarity, and that it is of appropriate magnitude to achieve a predetermined degree of homogeneity of the overall magnetic field generated by the primary coil system 10. Typically, the magnitude of each correction current is small, in the order of 1 ampere, as compared with the main current of (typically) 400 to 500 amperes that flows through the entire primary coil system 10, during operation, to generate the powerful magnetic field required of an MRI system. Each correction current is preferably superposed on the main current as required to achieve a desired electrical shimming effect. While the invention has been particularly described in the context of a superconducting magnet for MRI imaging, the present invention may be applied to any situation in which an electromagnet made up of a number of coils is required to produce a homogeneous field, such as magnetic resonance spectroscopy systems or particle accelerators.

Although modifications and changes may be suggested by those skilled in the art, it is the intention of the inventors to embody within the patent warranted hereon all changes and modifications as reasonably and properly come within the scope of their contribution to the art.

I claim as my invention:

1. A magnet system for generating a substantially homogenous magnetic field within a region, said magnet system comprising:
a primary magnetic coil system that generates a magnetic field having correctable inhomogeneities therein, said primary magnetic coil system comprising a plurality of primary coil portions supported respectively at predetermined positions relative to each other, said plurality of primary coil portions being electrically connected in series and carrying a common primary coil current during operation of the primary magnetic coil system; and
a corrective component that interacts with said primary coil system to selectively supply a corrective electric current to a subset of said primary coil portions, said corrective component superimposing said corrective current on said primary current in said subset of primary coil portions to at least reduce said inhomogeneities.

2. A magnet system as claimed in claim 1 wherein said subset of primary coil portions consists of coil portions that are electrically adjacent to each other.

3. A magnet system as claimed in claim 1 wherein said primary coil portions are comprised of superconducting material, and comprising a cooling system that cools said primary coil portions to a temperature making said primary coil portions superconducting.

4. A magnet system as claimed in claim 3 wherein said corrective component comprises a superconducting switch connected across said subset of primary coil portions.

5. A magnet system as claimed in claim 1 comprising a former that supports said plurality of primary coil portions in said predetermined positions relative to each other.

6. A magnet system as claimed in claim 5 wherein said former comprises pre-defined channels therein, and wherein said primary coils are wound into said predefined channels and are encapsulated therein.

7. A magnet system as claimed in claim 5 wherein said former is molded to a predetermined shape, and wherein said primary coils are wound on said former and are encapsulated thereon.

8. A magnet system as claimed in claim 1 wherein said primary magnetic coil system includes an end coil portion, as one of said plurality of primary coil portions therein, and wherein said subset of primary coil portions comprises said end coil portion.

9. A magnet system as claimed in claim 6 comprising a former on which said plurality of primary coil portions are supported at said relative positions, said former having a former end, and said end coil portion of said primary magnetic coil system being supported on said former proximate said former end.
